(19) United States
(12) Patent Application Publication
(10) Pub. No.: US 2001/0013040 A1
(43) Pub. Date: Aug. 9, 2001

(54) General purpose resource manager for hierarchical file systome

(75) Inventors: Sascha Baumeister, Stuttgart (DE); Gerd Breiter, Wildberg (DE)

Correspondence Address: Blanche E. Schiller, Esq., HESLIN & ROTHENBERG, P.C., 5 Columbia Circle, Albany, NY, 12203, US

(73) Assignee: International Business Machines Corporation, Armonk, NY (US)

(21) Appl. No.: 09/745,312

(22) Filed: Dec. 21, 2000

(30) Foreign Application Priority Data
Dec. 30, 1999 (EP) 99126180.1

(51) Int. Cl. G06F 17/30

(52) U.S. Cl. 707/201; 707/10; 707/8

(57) ABSTRACT

According to the basic principles of the present invention inventional transaction program means (20) is provided for cooperation with a conventional hierarchical file system (10) which provides it with transactional functionality. A file system (10) managed according to the inventional method can thus be seen as a file resource with which transaction processes, e.g., commit and rollback processes can be realized. This is advantageously achieved by implementing a transaction resource interface which acts as a wrapper program or a shell around the prior art file system and which can be accessed by a prior art transaction manager for achieving cooperation and data consistency between the file system (10) and any database (30), or between two or more file systems (10).

### PRIOR FOREIGN APPLICATION

This application claims priority from European patent application number 99126180.1, filed Dec. 30, 1999, which is hereby incorporated herein by reference in its entirety.

### TECHNICAL FIELD

The present invention relates to method and system for managing data stored in hierarchical file systems.

### BACKGROUND ART

A very common form to store business-relevant data is to use a data base. This kind of storage has the advantage that a high degree of data security, data availability and data consistency can be realized in the very common situation where a plurality of end-users access the data for read or write and where it is required for all of the users to read the same data and—if the data is updated—to manage the update process in a way in which it is guaranteed that all of the users read the updated data. Data bases are known to provide these qualities.

In today's business environments, however, an increasing number of business-relevant data is not stored anymore in data bases, but, instead, data is stored in hierarchical file systems. Thus, more and more situations can be found in which a particular data set is stored in a traditional data base on the one hand and—on the other hand—at the same time related information is stored in a file system residing on the same or on a different server.

Then the problem exists to hold this data consistent with each other when for example some business applications access these data for reading from and writing to it.

The same problem of missing data consistency is present when related data is stored in more than one file system-based storage units.

If related data residing in different resources (e.g. Database and File System) has to be updated consistently this is done by utilizing transactional services. When the transactional approach is used the following advantages can be achieved:

A transaction is atomic, i.e., if a transaction is interrupted by any failure all effects are undone, i.e. they are rolled back. Further if a transaction is committed by a transaction manager consistent results are produced. That means if an update of some data is committed to be performed the end-user can rely on accessing the updated data with the next access. Further, a transaction is isolated which means that the intermediate states are not visible to other transactions.

Thus, transactions appear to execute serially even if they are performed concurrently. This feature is of great importance in many reservation systems, as for example in an electronic purse system, or, in a travel agency. Further, any transaction is durable, i.e. the effects of a committed transaction are persistent such that they are never lost except in a catastrophic failure.

The problem is now to extend the possibilities given by the transactional approach to data stored in file systems without any data base management support.

A quite unattractive prior art approach to combine both paradigms is to store the data from the file system as a binary large object (BLOB) in the data base as well. The problem, however, is that performance is strongly reduced when an end-user wants to access the BLOB in order to read some of the data stored therein. Thus, intolerable latency time and bad scalability comes along with the approach.

Another way of doing transactional resource management of files is by handling this resource management explicitly in an application program. Besides the effort doing so that has to be spent in an application, the transaction manager has to offer application callbacks that allow it to take over control in case of prepare to commit, commit and rollback. This results, however, to an enormous amount of work for programming and maintenance.

### SUMMARY OF THE INVENTION

It is thus an object of the present invention to provide a method and system for managing data stored in a file system such that the above mentioned advantages of the transactional context can be used in file systems, as well without the impact of too much programming and maintenance work.

These objects of the invention are achieved by the features stated in various of the claims. Further advantageous arrangements and embodiments of the invention are set forth in the claims. Reference should now be made thereto.

According to the basic principles of the present invention inventional transaction program means is provided for cooperation with a conventional file system which provides it with transactional functionality. By this inventional principle a file system is able to be managed as a file resource in the transactional context usually applied to database technology. Thus, the inventional transaction program means is referred to herein as file resource manager (FRM).

A file system managed according to the inventional method can thus be seen as a tree of file resources with which the above mentioned transaction processes, e.g., commit and rollback processes can be realized. This is advantageously achieved by implementing a transaction resource interface which acts as a wrapper program around the prior art file system and which can be accessed by a prior art transaction manager for achieving cooperation and data consistency between the file system and any database, or between two or more file systems.

The file resource manager can advantageously be implemented as sitting “aside” of the regular prior art hierarchical file system and communicating with it via protocols such as the XDSM protocol or, alternatively, it can be implemented as a “stacked file system”, i.e. as a shell for application programs offering a reference to all usual file access commands issued by the application(s) and implementing additional own code which represents the transactional capabilities. Or, in an open file system code as provided by LINUX, for example, the inventional contribution might be implemented in the file system code itself, as well. In other words, the normal file access API implementation is extended by the file resource manager, and the latter additionally offers an implementation for the transactional prepare to commit, commit and rollback calls.

A considerable advantage is that the files and directories which are managed by the inventional file resource manager can be treated as resources that can be handled in a transactional context. With this remarkable feature a concurrent read/write on files and/or directories is able to be realized. Further, a concurrent read and delete access on files and/or directories can be realized as well. Further the traditional and reliable two-phase commit approach can be applied to file systems as well.

The inventional file system resource manager advantageously implements a two-phase commit protocol such as an XA-protocol.

Further, the file resource manager can be customized to define particular parts of the file system file tree to be subjected to transactional treatment.

The following scenarios roughly describe the inventional operation of the file resource manager within a two-phase commit transactional system context. The context comprises a transaction manager in cooperation with a prior art database management system in which business data is stored that is related to the file system data, and which thus must be stored consistently.

In particular, when an exemplary application program issues the basic commands relevant for changes made to a file system, i.e., a create file, delete file or update file the following basic way to proceed is performed according to the present invention:

Create File (Filename):

A new workfile with the given filename is created and a file handle is returned to the application. The existence of the workfile is hidden to all applications by the file resource manager. The application which created the file can access and possibly modify that workfile.

If a prepare to commit for this file is issued by the Transaction Manager the workfile is closed. If, thereafter, a commit is issued the workfile is made visible for all applications. If a rollback is issued instead, the workfile is deleted.

Delete File (Filename):

The file resource manager stores a flag that marks the file as to be deleted.

If a prepare to commit for this file is issued nothing is done. If a commit is issued after that a close is forced for the original file and the original file is deleted.

Update File (Filename):

When an application opens an original file for update, the file resource manager copies the content of the original file to a workfile with a generated name (filename1), stores the association between filename and filname1 and returns a handle which references the workfile. This means that this application works on the workfile instead of the original file. The file resource manager ensures that the workfile is not visible for normal file system accesses.

If a prepare to commit for this file is issued by the Transaction Manager the workfile is closed. If a commit is issued after that a close is forced for the original file, the original file is deleted, and the workfile is renamed to the filename the original file had. If a rollback is issued instead the workfile is deleted.

### BRIEF DESCRIPTION OF THE DRAWINGS

The present invention is illustrated by way of example and is not limited by the shape of the figures of the accompanying drawings in which:

FIG. 1 is a schematic representation showing the basic elements involved during the inventional file resource management method, applied for a concurrent read/write situation onto the same file;

FIG. 2 is a schematic block diagram showing the various steps involved in the control flow during the inventional method; and

FIG. 3 is a schematic representation showing the basic elements involved during the inventional file resource management method, applied for two different business situations.

### BEST MODE FOR CARRYING OUT THE INVENTION

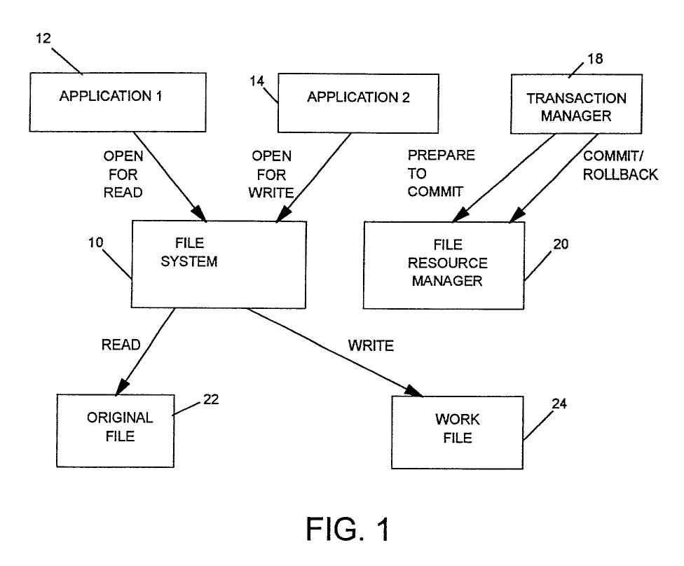

With reference now to FIG. 1 the basic hardware and software components which form part of the inventional system context are shown for a situation in which a concurrent read/write to one and the same file is managed by a preferred embodiment of the inventional method.

A prior art file system 10 can be accessed by two different application programs 12 and 14, respectively in a UNIX system environment. In this example application 1 is limited to a read access on files within the file system 10 whereas application 2 can perform read and write access to the same file of the file system.

The system depicted in FIG. 1 further comprises a transaction manager component 18 which manages all changes performed by application 2 in a transactional context as described above in the introductory chapter. Thus, the transaction manager may issue commands like ‘prepare to commit’, ‘commit’ or ‘rollback’. According to the present invention the inventional program component 20 referred to as file resource manager is depicted as switched aside of the file system 10. In this example the XDSM protocol is used within the file resource manager as an interface between the above mentioned application programs and the actual file system 10. Advantageously, the file resource manager is implemented as a subcomponent of the file system. Thus, the applications 12, 14 are depicted to direct their accesses (arrows) to the file system. The file resource manager 20, however, takes over the control on these accesses and calls the file system by itself.

Further, an original file 22 is depicted as well as a work file 24 as exemplary files which are read or written to by one of the applications 1, or 2, respectively.

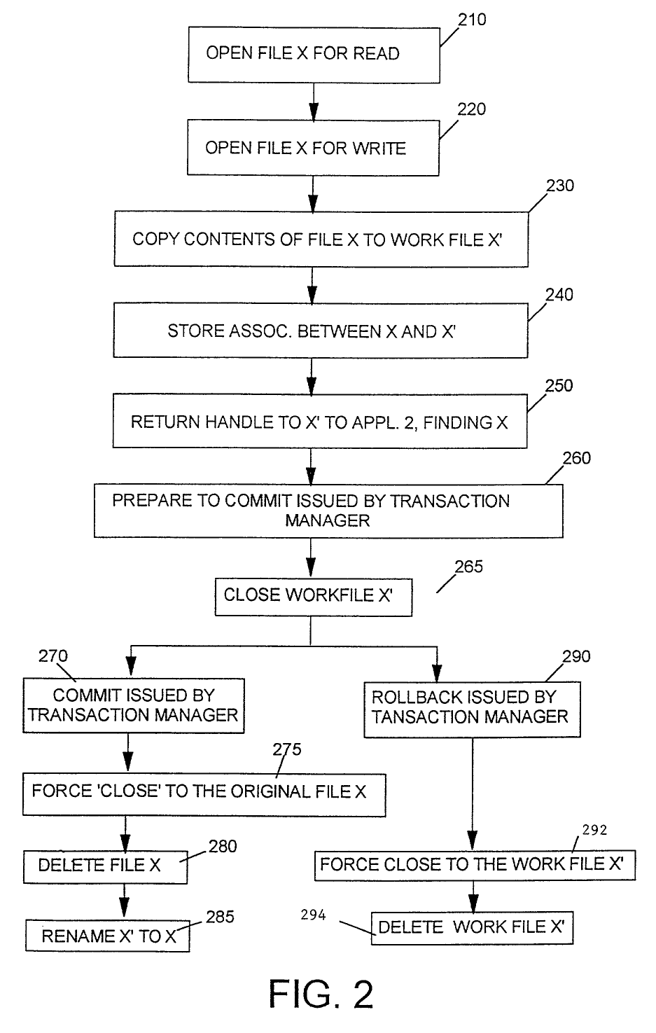

With additional reference now to FIG. 2 the basic steps and control during the inventional method is described in more detail for the above described situation in which application 2 writes to a file which application 1 concurrently reads.

In a first step 210 application 1 opens the original file 22 for a read access. During a time in which the original file is open application 2 opens the same file X for a write access, step 220. The inventional file resource manager catches via the XDSM interface the file open command of application 2 before it has any real effect onto the file system itself. According to the present invention the file resource manager is responsive to the application 2's file open command and generates a copy of the original file 22 to a work file 24 referred to as X′, in a step 230. Further, the file resource manager stores the association between the file name of the original file X and the work file X′ (step 240) and returns a file handle to application 2 which references the work file (step 250). Thus, application 2 works on the work file instead of the original file. According to a basic feature of the present invention the file resource manager 20 ensures that the work file 24 is not visible for regular, i.e. normal file system accesses. Application 1 still reads the original file.

When the above mentioned transaction manager 18 issues a command ‘prepare to commit’ for the original file 22 in a step 260 the work file 24 will be closed in a step 265. These steps 260, 250 usually happen when the changes made during the write access to the work file 24 have been completed as it was intended by the end-user associated with application 2. Thus, the changes made thereby are intended to become valid in the file system 10.

When a commit command is issued subsequently by the transaction manager 18 in a step 270 the original file 22 is forced to be closed by the transaction manager. The read process is to be terminated. This can be performed by the transaction manager itself, or, alternatively by the inventional file resource manager, as well. After the original file 22 was closed in a step 275 the original file X is deleted in a step 280 and, immediately after deleting it the work file 24 is renamed to the original file 22 in a step 285. Thus, all fresh changes from the work file 24 can now be retrieved in the original file 22. Otherwise, when the transaction manager issues a rollback command in a step 290 after the work file was closed in the step 265 the old and original content of the original file 22 is intended to be saved and the changes made in the work file 24 are intended to be discarded. Thus, in a step 292 the work file is forced to be closed as mentioned above. Then, in a step 294 the work file 24 is deleted and the original file 22 can be accessed again for further read accesses and further write access.

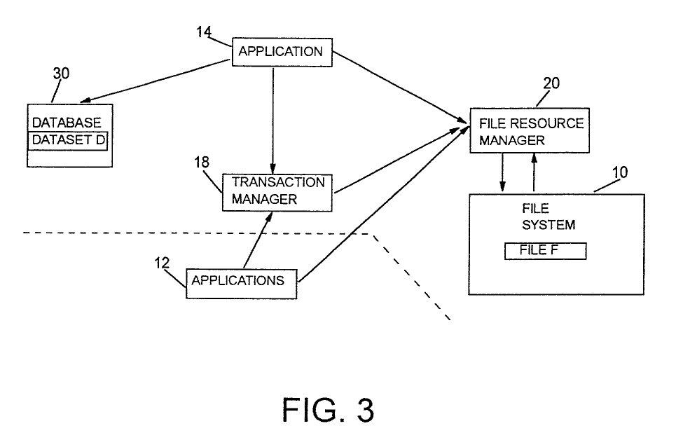

With reference now to FIG. 3 two further typical situations are illustrated in which the inventional file resource managing method can be advantageously applied. In both situations the basic inventional principles of forming a shell around the file system breaking up the original connection between file access commands and the original file system and redirecting or extending those file access commands to the inventional file resource manager component 20 are exploited:

The first situation is depicted in the upper portion of FIG. 3 separated with a broken line from any effects of application 12.

Here, related business data—data set D is stored in a prior art database 30 as well as file F in a file system 10 which is inventionally managed by the file resource manager 20. Application 14 has to perform changes to both datasets comprising related business data. The transaction manager 18 is connected to or forms part of the database management system 30 depending on the actual business situation. When the two-phase commit scenario is applied as described with reference to FIG. 2 any related stored business data like the dataset D stored in the database 30 can be held consistent with the corresponding file F stored in the file system 10. A concrete example for this would be a video library where the videos are stored as files in the file system and related descriptive information of the respective video is stored in the database. If a video is altered the description is to be altered consistently to reflect the changed video content. This has to happen in a transactional context reflecting the “all or nothing” paradigm of transactions. That means that in case of a “commit” both—the video and the descriptive tables—are updated and made persistent. In case of “rollback” it is guaranteed that none of the changes is made persistent.

In the foregoing specification the invention has been described with reference to a specific exemplary embodiment thereof. It will, however, be evident that various modifications and changes may be made thereto without departing from the broader spirit and scope of the invention as set forth in the appended claims. The specification and drawings are accordingly to be regarded as illustrative rather than in a restrictive sense.

The inventional file resource manager can be used for every application which needs to update files in a transactional context. This includes resource management of files in Enterprise Java Beans transactions as a concrete example where a mainframe file system could exploit the inventional idea.

The present invention can be realized in hardware, software, or a combination of hardware and software. A file resource manager tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following:

a) conversion to another language, code or notation;

b) reproduction in a different material form.

What is claimed is:

1. A method for managing a file system comprising:
providing transaction program means arranged for a cooperation with said file system, said transaction program means implementing transactional functionality to changes of said file system.

2. The method according to claim 1 in which said transaction program means implements a commit and/or rollback facility.

3. The method according to claim 1 in which said transaction program means is arranged for communicating with said file system via a protocol directed to cover changes made to said file system.

4. The method according to claim 3 in which said protocol is XDSM or is derivable from XDSM, or comprises XDSM-equivalent functions.

5. A method for managing a file system comprising using transaction program means according to claim 4 implemented for a cooperation with said file system.

6. A computer system being able to access a file system which is manageable by transaction program means according to a method of claim 4.

7. A computer program for execution in a data processing system comprising computer program code portions for performing the steps of the method of claim 4.

8. A computer program product stored on a computer usable medium comprising computer readable program means for causing a computer to perform the method of claim 4.

9. The method according to claim 1 in which said transaction program means is implemented as a stacked file system.

10. The method according to claim 1 in which said transaction program means is implemented in the file system itself.

11. The method according to claim 1 in which said transaction program means processes commands issued by transaction manager means arranged for cooperating with a database management system.

12. A method for managing a file system comprising using transaction program means according to claim 1 implemented for a cooperation with said file system.

13. A computer system being able to access a file system which is manageable by transaction program means according to a method of managing a file system comprising:
providing transaction program means arranged for a cooperation with said file system, said transaction program means implementing transactional functionality to changes of said file system.

14. A computer program for execution in a data processing system comprising computer program code portions for performing the steps of providing transaction program means arranged for a cooperation with said file system, said transaction program means implementing transactional functionality to changes of said file system.

15. A computer program product stored on a computer usable medium comprising computer readable program means for causing a computer to perform the method of managing a file system comprising:
providing transaction program means arranged for a cooperation with said file system, said transaction program means implementing transactional functionality to changes of said file system.
